(19) United States
(12) Patent Application Publication
(10) Pub. No.: US 2025/0097866 A1
(43) Pub. Date: Mar. 20, 2025

(54) MEASUREMENT GAP MANAGEMENT IN A NON-TERRESTRIAL NETWORK

(71) Applicant: Google LLC, MOUNTAIN VIEW, CA (US)

(72) Inventors: Ming-Hung TAO, Taoyuan City (TW); Chih-Hsiang WU, Taoyuan City (TW)

(21) Appl. No.: 18/724,049

(22) PCT Filed: Jan. 7, 2023
(86) PCT No.: PCT/US2023/010366

§ 371 Date: Jun. 25, 2024

Related U.S. Application Data
(60) Provisional application No. 63/297,686, filed on Jan. 7, 2022.

(51) Int. Cl. H04W 56/00; H04W 74/0833; H04W 84/06

(52) U.S. Cl. CPC H04W 56/0015; H04W 74/0841; H04W 84/06

(57) ABSTRACT

A user equipment (UE) receives, from a non-terrestrial network (NTN), a measurement configuration that indicates a timing pattern for inter-frequency measurement, the timing pattern including a measurement gap of a certain duration. The UE receives, from the NTN, a synchronization signal during the measurement gap in accordance with the timing pattern, performs a measurement of the synchronization signal; and transmits, to the NTN, an indication related to the measurement gap. For example, the indication may be a request to terminate early the measurement gap.

### FIELD OF THE DISCLOSURE

This disclosure relates generally to wireless communications and, more particularly, to synchronizing measurements of signals transmitted from non-terrestrial network nodes such as satellites.

### BACKGROUND

This background description is provided for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

The objectives behind developing the fifth generation (5G) technology include providing a unified framework for such types of communication as enhanced mobile broadband (eMBB), ultra-reliable low-latency communications (URLLC), and massive machine type communication (mMTC).

The 5G technology relies primarily on legacy terrestrial networks. However, the 3rd Generation Partnership Project (3GPP) organization has proposed to extend 5G communications to non-terrestrial networks (NTNs) with 5G new radio (NR) technologies, or with the Long-Term-Evolution (LTE) technologies tailored for the Narrowband Internet-of-Thing (NB-IoT) or the enhanced Machine Type Communication (eMTC) scenarios. In an NTN, an RF transceiver is mounted on a satellite, an unmanned aircraft systems (UAS) also referred to as drone, balloon, plane, or another suitable apparatus. For simplicity, the discussion below refers to all such apparatus as satellites. In addition to satellites, an NTN can include the sat-gateways that connect the Non-Terrestrial Network to a public data network, feeder links between sat-gateways and satellites, service links between satellites, and inter-satellite links (ISL) when satellites form constellations.

A satellite can belong to one of several types based on altitude, orbit, and beam footprint size. The types include Low-Earth Orbit (LEO) satellite, Medium-Earth Orbit (LEO) satellite, Geostationary Earth Orbit (GEO) satellite, UAS platform (including High Altitude Platform Station (HAPS)), and High Elliptical Orbit (HEO) satellite. GEO satellites are also known as the Geosynchronous Orbit (GSO) satellites, and LEO/MEO satellites are also known as non-GSO (NGSO) satellites.

A GSO satellite can communicate with one or several sat-gateways deployed over a satellite targeted coverage area (e.g. a region or even a continent). A non-GSO satellite at different times can communicate with one or several serving sat-gateways. An NTN is designed to ensure service and feeder link continuity between successive serving sat-gateways, with sufficient time duration to proceed with mobility anchoring and hand-over.

A satellite typically generates several beams for a given service area bounded by the field of view. The footprints of the beams depend on the on-board antenna configuration and the elevation angle and typically have an elliptic shape. A satellite can support a transparent or a regenerative (with on board processing) payload. For a transparent payload implementation, a satellite can apply RF filtering and frequency conversion and amplification, and not change the waveform signal. For a regenerative payload implementation, a satellite can apply RF filtering, frequency conversion and amplification, demodulation and decoding, routing, and coding/modulation. This regenerative approach is effectively equivalent to implementing most of the functions of a base station, e.g., a gNB.

NB-IoT and eMTC technologies are expected to be particularly suitable for IoT devices operating in remote areas with limited or no terrestrial connectivity. Such IoT devices can be used in a variety of industries including for example transportation (maritime, road, rail, air) and logistics; solar, oil, and gas harvesting; utilities; farming; environmental monitoring; and mining. However, to ensure the required IoT connectivity, deployment of these technologies requires satellite connectivity to provide coverage beyond terrestrial deployments. Satellite NB-IoT or eMTC is defined in a complementary manner to terrestrial deployments.

To determine whether to initiate a handover or carrier aggregation, for example, a UE can monitor the signal in cells other than the cell in which the UE currently operates, i.e., the serving cell. To this end, base stations generate synchronization signals such as a Synchronization Signal (SS) and Physical Broadcast Channel (PBCH) Block (SSB). Each cell can have a particular configuration of SSB periodicity. According to 3GPP specifications, a UE receives a SSB-based RRM Measurement Timing Configuration (SMTC) for a certain carrier frequency in order to determine the SSB periodicity setting and the burst duration. Further, an SMTC can indicate the timing offset of the SSB burst in a frame. For NR Release 15, 3GPP supports an SMTC periodicity between 5 and 160 ms, and a burst window duration between 1 ms and 5 ms. When a UE performs inter-frequency measurements by receiving and processing SSBs on non-serving frequencies, the UE does not monitor the serving frequency during a time period referred to as the measurement gap.

In contrast to a typical terrestrial network, an NTN can have large propagation delays between UEs and satellites, as well as large variance in these delays. A serving satellite may provide a UE with an SMTC window that does not align with the times when SSB bursts from non-serving satellites reach the UE, which requires certain adjustments in the timing of UE measurements. Further, because satellites move relative to each other (e.g., the distance between the serving satellite and a non-serving satellite changes over time), the UE may encounter gradual timing misalignments, when the propagation delay between a non-serving satellite and the UE effectively moves an SSB burst into an earlier or a later subframe relative to the time pattern that the serving satellite established.

### SUMMARY

An example embodiment of the techniques of this disclosure is a method for synchronization signal measurement implemented in a user equipment (UE), the method comprising: receiving, by the UE from a non-terrestrial network (NTN), a measurement configuration that indicates a timing pattern for inter-frequency measurement, the timing pattern having a measurement gap of a certain duration; receiving, by the UE from the NTN, a synchronization signal during the measurement gap in accordance with the timing pattern; performing, by the UE, a measurement of the synchronization signal; and transmitting, by the UE to the NTN, an indication related to the measurement gap.

Another example embodiment of these techniques is a user equipment (UE) comprising a transceiver and processing hardware configured to implement the method above.

Another example embodiment of these techniques is a method for configuring synchronization signal measurement in a user equipment (UE), the method implemented in a serving non-terrestrial network (NTN) node and comprising: transmitting, by the NTN node to a UE, a measurement configuration that indicates a timing pattern for inter-frequency measurement at the UE, the timing pattern having a measurement gap of a certain duration; receiving, by the NTN node from the UE, an indication related to the measurement gap; and modifying, by the NTN node, the timing pattern in accordance with the received indication.

Another example embodiment of these techniques is a non-terrestrial network (NTN) node comprising a transceiver, and processing hardware configured to implement the method above.

### BRIEF DESCRIPTION OF THE DRAWINGS

FIG. 1 is a block diagram of an example communication system in which the techniques of this disclosure can be implemented;

FIG. 2 illustrates a functional split between a radio network and a core network, according to which the system of FIG. 1 can operate;

FIG. 3A is a block diagram of an example NTN node with transparent payload implementation;

FIG. 3B is a block diagram of an example NTN implementation in which a base station connects to multiple satellites via the same sat-gateway;

FIG. 4A illustrates an example user plane protocol stock for use with the architecture of FIG. 3A;

FIG. 4B illustrates an example control plane protocol stock for use with the architecture of FIG. 3A;

FIG. 5 illustrates an example scenario in which a UE applies a combined gap pattern that incorporates multiple gap patterns corresponding to different respective non-serving satellites;

FIG. 6 illustrates an example scenario in which a UE requires a longer combined gap pattern than the combined gap pattern of FIG. 5, due to movement of the non-serving satellites away from the serving satellite;

FIG. 7A illustrates an example scenario in which a UE sends, to a serving satellite, a request to terminate the measurement gap early;

FIG. 7B illustrates an example scenario in which a UE sends, to a serving satellite, a recommendation regarding a new measurement gap;

FIG. 8 illustrates an example scenario in which a serving satellite provides, to a UE operating a connected state, a drifting parameter along with a measurement configuration;

FIG. 9 illustrates an example scenario in which a serving satellite provides, to a UE operating a connected state, the value for a validity timer along with a measurement configuration;

FIG. 10 illustrates an example scenario in which a serving satellite provides, to a UE operating a connected state, a sequence of time patterns and a sequence of values for the respective validity timers;

FIG. 11 is a flow diagram of an example method for managing a gap pattern, which can be implemented in a UE of this disclosure;

FIG. 12 is a flow diagram of an example method for providing a UE with an updated measurement configuration, which can be implemented in an NTN node of this disclosure;

FIG. 13 is a flow diagram of another example method for managing a gap pattern, which can be implemented in a UE of this disclosure; and

FIG. 14 is a flow diagram of an example method for providing a UE with an updated measurement configuration, which can be implemented in an NTN node of this disclosure.

### DETAILED DESCRIPTION OF THE DRAWINGS

An NTN node of this disclosure, such as a serving or connected satellite, allows a UE to terminate the gap pattern early, i.e., prior to the end of the measurement gap, and/or provide a recommendation regarding future gap patterns when the current measurement gap completes. The gap pattern can be relatively long to accommodate multiple timing patterns according to which respective non-serving satellites transmit synchronization signals. The serving satellite transmits a certain measurement configuration to the UE and indicates that the serving satellite is configured to process requests to terminate the measurement gap early and/or process recommendations regarding future gap patterns.

When the UE determines (in some cases, implicitly) that the satellite supports UE notifications regarding the gap pattern, the UE in some cases determines that it has completed the necessary measurements prior to the end of the measurement gap and transmits a request to terminate the measurement gap early. The UE then can receive downlink data within the remainder of the terminated measurement gap. The UE in other cases transmits a recommendation regarding future gap patterns. The UE can request that the serving satellite extend the measurement gap or, conversely, shorten the measurement gap.

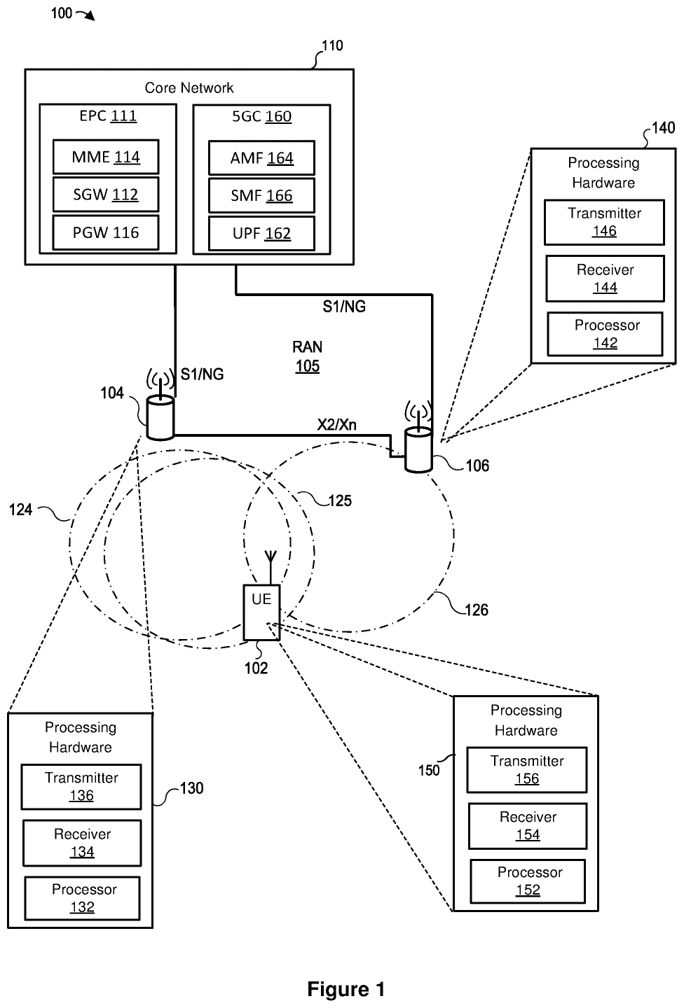

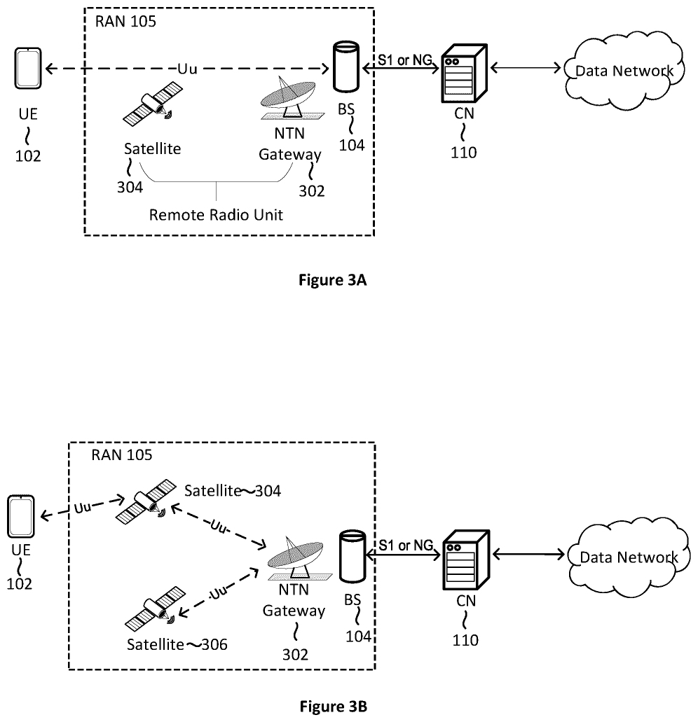

Referring first to FIG. 1, an example wireless communication system 100 includes a UE 102, a base station (BS) 104, a base station 106, and a core network (CN) 110. The base stations 104 and 106 can operate in a RAN 105 connected to the core network (CN) 110 and other base station components, such as satellites, as will be described with reference to FIGS. 3A and 3B. The CN 110 can be implemented as an evolved packet core (EPC) 111 or a fifth generation (5G) core (5GC) 160, for example. The CN 110 can also be implemented as a sixth generation (6G) core and future evolutions.

The base station 104 covers a cell 124, and the base station 106 covers a cell 126. If the base station 104 is a gNB, the cell 124 is an NR cell. If the base station 104 is an ng-eNB or eNB, the cell 124 is an evolved universal terrestrial radio access (E-UTRA) cell. Similarly, if the base station 106 is a gNB, the cell 126 is an NR cell, and if the base station 106 is an ng-eNB or eNB, the cell 126 is an E-UTRA cell. The cells 124 and 126 can be in the same Radio Access Network Notification Areas (RNA) or different RNAs. In general, the RAN 105 can include any number of terrestrial and non-terrestrial base stations, and each of the base stations can cover one, two, three, or any other suitable number of cells. The UE 102 can support at least a 5G NR (or simply, “NR”) or E-UTRA air interface to communicate with the base stations 104 and 106. Each of the base stations 104, 106 connect to the CN 110 via an interface (e.g., S1 or NG interface). The base stations 104 and 106 also can be interconnected via an interface (e.g., X2 or Xn interface) for interconnecting NG RAN nodes.

Among other components, the EPC 111 can include a Serving Gateway (SGW) 112, a Mobility Management Entity (MME) 114, and a Packet Data Network Gateway (PGW) 116. The SGW 112 in general is configured to transfer user-plane packets related to audio calls, video calls, Internet traffic, etc., and the MME 114 is configured to manage authentication, registration, paging, and other related functions. The PGW 116 provides connectivity from the UE to one or more external packet data networks, e.g., an Internet network and/or an Internet Protocol (IP) Multimedia Subsystem (IMS) network. The 5GC 160 includes a User Plane Function (UPF) 162 and an Access and Mobility Management Function (AMF) 164, and/or Session Management Function (SMF) 166. Generally speaking, the UPF 162 is configured to transfer user-plane packets related to audio calls, video calls, Internet traffic, etc., the AMF 164 is configured to manage authentication, registration, paging, and other related functions, and the SMF 166 is configured to manage PDU sessions.

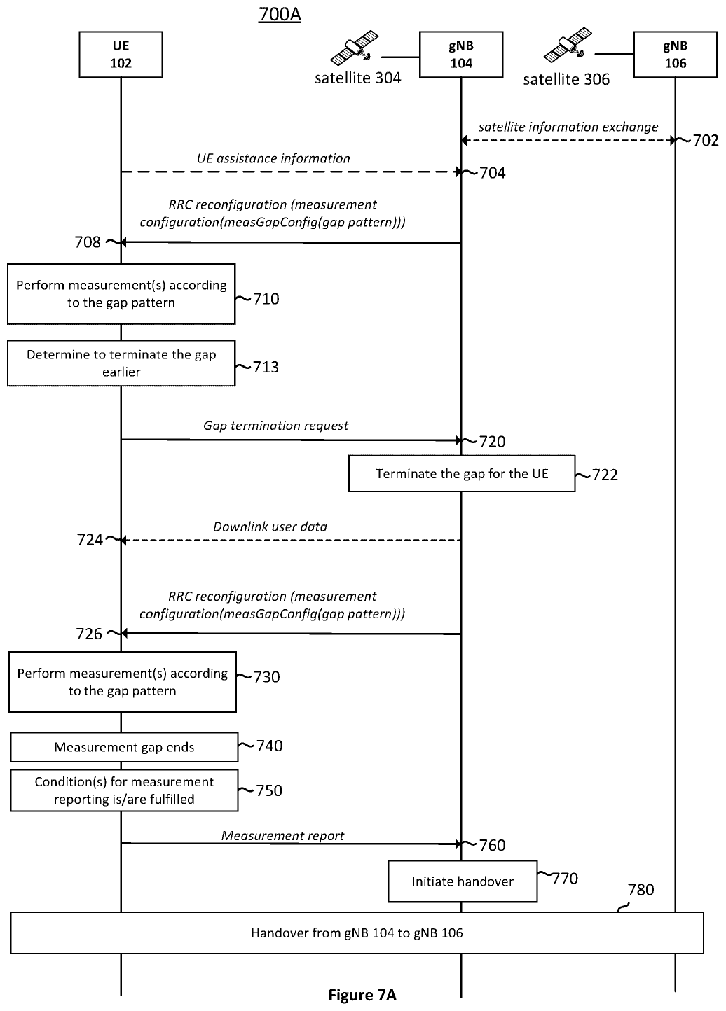

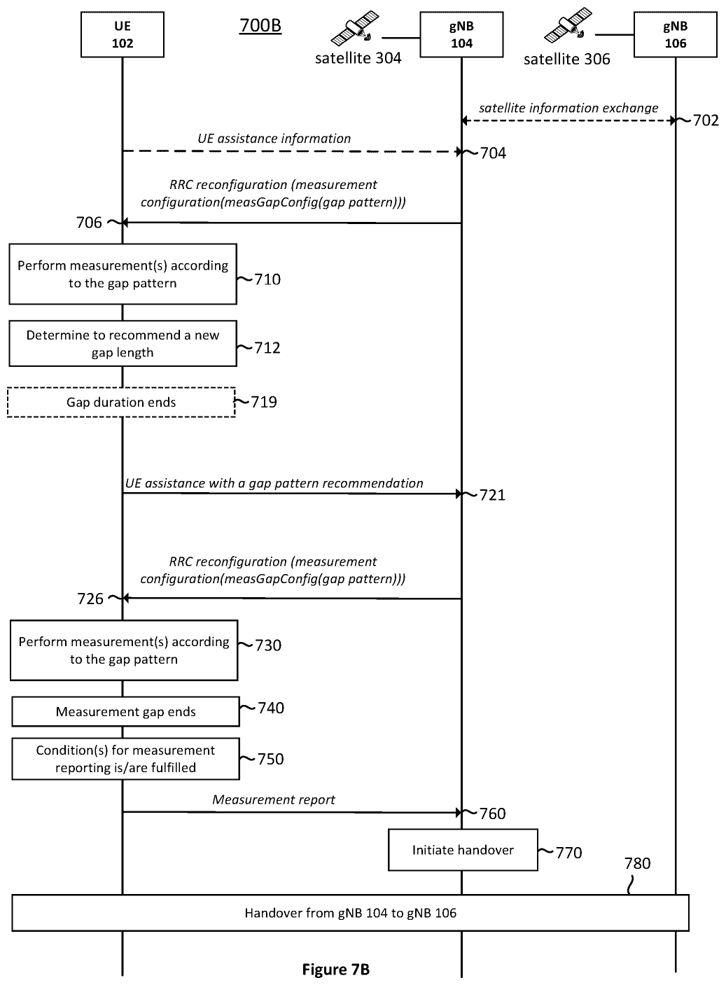

As illustrated in FIG. 1, the base station 104 supports a cell 124, and the base station 106 supports a cell 126. The cells 124 and 126 can partially overlap, so that the UE 102 can select, reselect, or hand over from one of the cells 124 and 126 to the other. Satellite base stations may provide additional RAN 105 coverage as described with reference to FIG. 7. To directly exchange messages or information, the base station 104 and base station 106 can support an X2 or Xn interface. In general, the CN 110 can connect to any suitable number of terrestrial and non-terrestrial base stations supporting NR cells and/or EUTRA cells.

As discussed in detail below, the UE 102 and/or the RAN 105 may utilize the techniques of this disclosure when the radio connection between the UE 102 and the RAN 105 is suspended, e.g., when the UE 102 operates in an inactive or idle state of the protocol for controlling radio resources between the UE 102 and the RAN 105. For clarity, the examples below refer to the RRC_INACTIVE or RRC_IDLE state of the RRC protocol. The UE 102 may further utilize the techniques of this disclosure when the radio connection between the UE 102 and the RAN 105 is disconnected and operating in a PSM where no radio resource control (RRC) protocol relationship exists between the UE and the network.

The base station 104 is equipped with a transceiver and processing hardware 130 that can include one or more general-purpose processors (e.g., CPUs) and a non-transitory computer-readable memory storing instructions that the one or more general-purpose processors execute. Additionally or alternatively, the processing hardware 130 can include special-purpose processing units. The processing hardware 130 in an example implementation includes a processor 132 to process data that the base station 104 will transmit in the downlink direction, or process data received by the base station 104 in the uplink direction. The processing hardware 130 can also include a transmitter 136 configured to transmit data in the downlink direction. The processing hardware further can include a receiver 134 configured to receive data in the uplink direction. The base station 106 can include generally similar components. In particular, components 140, 142, 144, and 146 of the base station 106 can be similar to the components 130, 132, 134, and 136, respectively.

The UE 102 is equipped with a transceiver and processing hardware 150 that can include one or more general-purpose processors such as CPUs and non-transitory computer-readable memory storing machine-readable instructions executable on the one or more general-purpose processors, and/or special-purpose processing units. The processing hardware 150 in an example implementation includes a processor 152 to process data that the UE 102 will transmit in the uplink direction, or process data received by UE 102 in the downlink direction. The processing hardware 150 can also include a transmitter 156 configured to transmit data in the downlink direction. The processing hardware further can include a receiver 154 configured to receive data in the uplink direction.

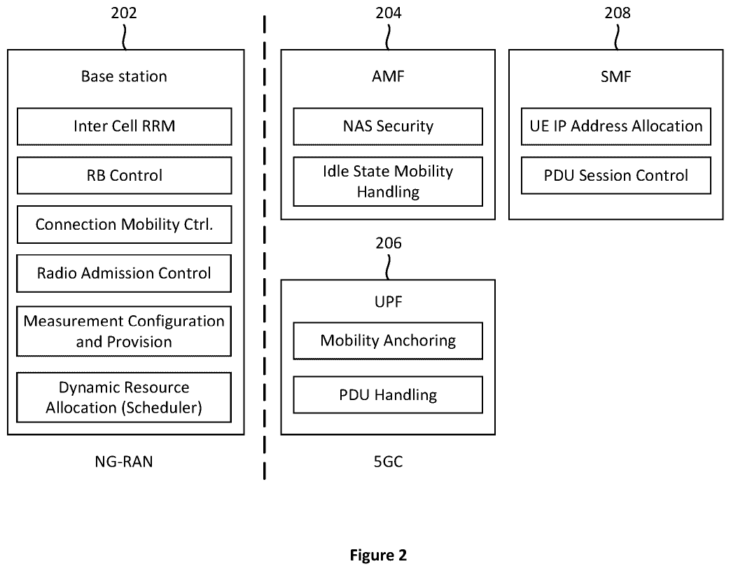

As illustrated in FIG. 2, various functionality can be distributed between the RAN 105 and the 5GC 160, and further distributed between different components of the 5GC 160, such as the AMF 164 and the SMF 166.

In particular, a base station 202 (e.g., the base station 104 or 106) can host the following main functions: Radio Resource Management such as Radio Bearer Control, Radio Admission Control, Connection Mobility Control, dynamic allocation of resources to UEs in both up-link and downlink (scheduling); IP header compression, encryption and integrity protection of data; selection of an AMF at UE attachment when no routing to an AMF can be determined from the information provided by the UE; routing of User Plane data toward the UPF(s); routing of Control Plane information towards the AMF; connection setup and release; scheduling and transmission of paging messages; scheduling and transmission of system broadcast information (originated from the AMF or Operations, Administration and Maintenance (OAM)); measurement and measurement reporting configuration for mobility and scheduling; transport level packet marking in the uplink; session management; support of network slicing; QoS flow management and mapping to data radio bearers; support of UEs in RRC_INACTIVE state; distribution of NAS messages; radio access network sharing; Dual Connectivity; and interworking between NR and E-UTRA.

The AMF 204 can host the following functionality: NAS signaling termination; NAS signaling security; AS security control; inter-CN node signaling for mobility between 3GPP access networks; Idle mode UE Reachability (including control and execution of paging retransmission); Registration Area management; support of intra-system and inter-system mobility; access authentication; access authorization including checking of roaming rights; mobility management control (subscription and policies); support of network slicing; and SMF selection.

The UPF 206 can host the following functionality: anchor point support for Intra-/Inter-RAT mobility (when applicable); external PDU session point of interconnect to data network support; packet routing & forwarding; packet inspection and user plane part of policy rule enforcement; traffic usage reporting; uplink classification to support routing traffic flows to a data network; branching point to support multi-homed PDU session; QoS handling for user plane, e.g. packet filtering, gating, UL/DL rate enforcement; uplink rraffic verification (SDF to QoS flow mapping); and downlink packet buffering and downlink data notification triggering.

Finally, the SMF 208 can provide session management; UE IP address allocation and management; selection and control of UP function; configuration of traffic steering at User Plane Function, UPF, to route traffic to proper destination; control of policy enforcement and QoS; and downlink data notification.

FIG. 3A illustrates a certain type of NTN deployment referred to as transparent payload architecture, which involves a satellite gateway 302 and a “transparent” satellite 304 for extending the range of the Uu interface. This NTN deployment may be incorporated into the RAN 105 of FIG. 1 as another base station or an extension of the base station 104 (or the base station 106). The satellite 304 implements a frequency conversion and a Radio Frequency (RF) amplifier in both the uplink and downlink directions. The satellite function is similar to that of an analogue RF repeater. Thus, the satellite 304 repeats the Uu radio interface from the feeder link (between the NTN gateway and the satellite) to the service link (between the satellite and the UE) in the downlink direction and vice versa in the uplink direction. The Satellite Radio Interface (SRI) on the feeder link is the Uu, and the NTN gateway 302 supports all necessary functions to forward the signal of the Uu interface. The NTN gateway 302 operate at the same site as the base station (e.g., eNB, gNB) 104 location, or connect to the base station 104 at a distance via a wired link. It is also possible to connect more than one NTN gateway to a base station. Different transparent satellites may be connected to the same base station on the ground, via the same NTN gateway, or via different NTN gateways.

FIG. 3B illustrates the implementation in which two different satellites (304 and 306) connect to the same base station 104 via the same NTN gateway 302, and these two satellites (304 and 306) are covering the Earth surface using two different Physical Cell IDs (PCIs).

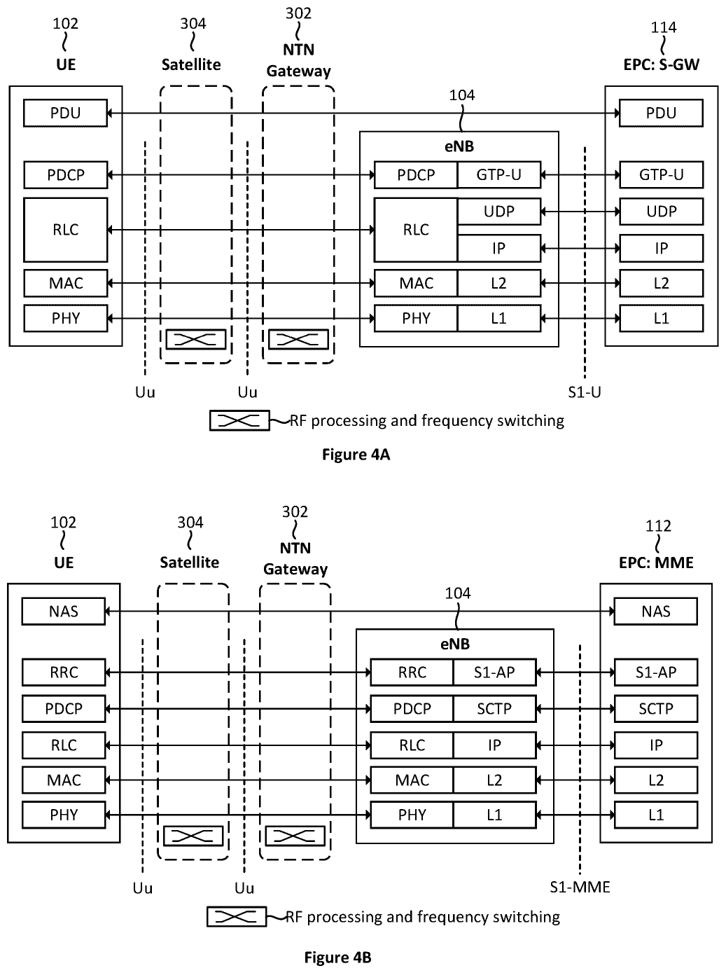

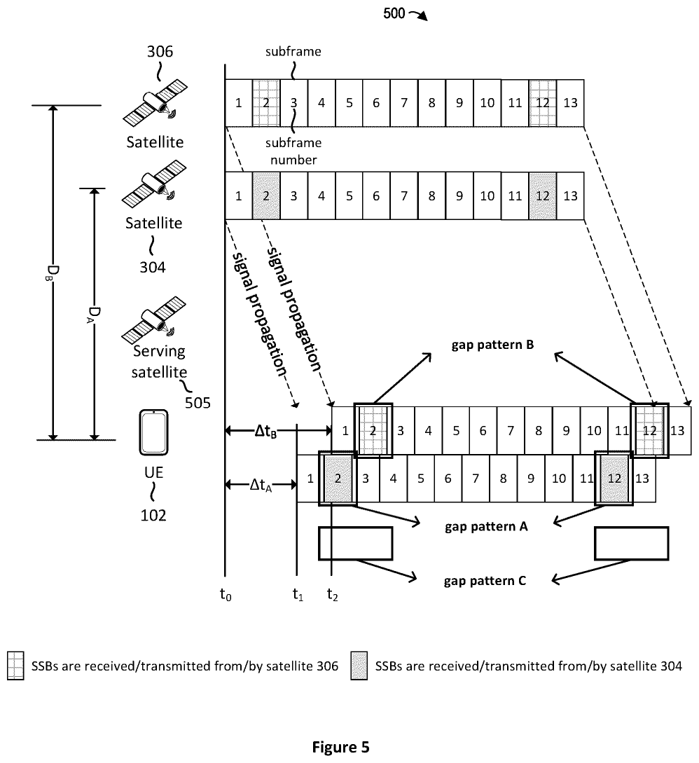

Next, FIG. 4A illustrates an NTN user-plane protocol stack involving the UE 102, the satellite 304, the NTN gateway 302, the base station 104, and the EPC S-GW 112 (or 5GC SMF 166). The NTN user-plane protocol stack is similar to that of the terrestrial network (TN), except that the configuration of FIG. 4A illustrates two additional nodes, the satellite 304 and the NTN gateway 302, operating in the middle of the Uu interface. Similarly, the NTN control plane protocol stack illustrated of FIG. 4B is also generally analogous to that of the terrestrial network counterpart shown in FIG. 2B.

Referring generally to FIGS. 1-4B, NTN supports at least three types of service links NTN, described in terms of satellite movement patterns: (i) Earth-fixed: provisioned by beam(s) continuously covering the same geographical areas all the time (e.g., the case of GEO/GSO satellites); (ii) Quasi-Earth-fixed: provisioned by beam(s) covering one geographic area for a limited period and a different geographic area during another period (e.g., the case of LEO/MEO satellites capable of using steerable beams); and (iii) Earth-moving: provisioned by beam(s) whose coverage area slides over the Earth surface (e.g., the case of LEO/MEO satellites using fixed or non-steerable beams).

With LEO/MEO satellites, a base station can provide either quasi-Earth-fixed cell coverage or Earth-moving cell coverage. With GEO satellites, the base station can provide Earth fixed cell coverage.

Although the transparent payload architecture illustrated in FIGS. 3A and 3B is the current focus of the 3GPP development, the regenerative payload architecture that places some of the base station functions on the satellite is also a possible NTN deployment in the future. In such an architecture, the Uu only exists between the satellite and the UE. In general, the techniques of this disclosure can apply to the transparent payload architecture as well as the regenerative payload architecture.

Again referring generally to FIGS. 1-4A, the UE 102 operating in a certain cell detects reference signals from the neighboring cells and measure the strength of the reference signals to be able to switch to a qualified neighboring cell when needed (i.e., when the serving cell is no longer able to serve the UE due to poor signal reachability), or in order to add a new Carrier Component (CC). The reference signal a base station can use for this purpose with the NR radio interface is the synchronization signal (SS) and physical broadcast channel (PBCH) block, abbreviated as SSB. Unlike the LTE radio interface in which a base station transmits SS every 5 ms, 5G NR allows each base station to transmit the SSB burst with different time patterns, with the longest periodicity of up to 160 ms. This allows the network to configure the SSB transmission in a more dynamic manner dependent on the actual usage and channel condition.

This approach helps to avoid unnecessary measurements and reduce the power consumption of a UE. However, this flexibility comes at the cost of the additional signaling required to inform the UE when to perform measurement on a measurement target. Without the additional signaling, the UE would need to assume the worst-case scenario (in the implementation above, the 5 ms periodicity) to determine when to measure the target. As a result, the UE achieves no power saving gain. This additional signaling in 5G NR is known as “SSB based measurement timing configuration (SMTC),” which contains a periodicity setting ranging from 5 ms to 160 ms and a duration setting ranging from 1 ms to 5 ms.

The network does not need to align the SMTC periodicity setting with the actual SSB burst periodicity. For instance, the SMTC periodicity can be set to a value larger than the SSB burst periodicity to further reduce the power consumption of the UE. In addition to the periodicity and duration settings, the SMTC also indicates a timing offset to inform the UE of the exact subframe where the UE should start monitoring the SSB burst, which occurs repeatedly according to the periodicity setting. A base station can signal the periodicity and the timing offset settings together, in one measurement object, as a single parameter periodicityAndOffset.

There can be a relatively small timing difference between the timing of the Primary Cell (PCell) and the timing of the measurement target, in part due to the propagation delay difference. A terrestrial network can ignore this small timing difference, as the propagation delay difference is small and hence requires no adjustment in the timing offset setting. Accordingly, 3GPP TS 38.331 (v16.6.0) currently specifies only one timing offset for the measurement object configuration. For a non-terrestrial network, however, the propagation delay between a satellite and a UE could be longer (e.g., up to 25.77 ms), and the variance for different satellites can be significant (e.g., between 8 ms and 25.77 ms).

A UE and/or a base station can use an individual timing offset setting associated with each respective measurement target (i.e., a satellite) configured in a measurement object. This approach can result in multiple timing offsets settings or even multiple SMTCs configured in one measurement object. Although a measurement object can support two SMTCs, these SMTCs currently share the same timing offset setting and hence cannot address the propagation delay issue in an NTN discussed above.

Now referring to a scenario 500 of FIG. 5, the satellite 505 currently is serving the UE 102 and has configured the UE 102 with an inter-frequency measurement object to perform the measurement on the cells of the neighbor satellites 304 and 306. This discussion assumes that (i) the satellites 505, 304, and 306 are fully synchronized, (ii) that the satellites 304 and 306 are operating in the same frequency band different from the carrier frequency of the serving satellite 505, and that (iii) the distance between the satellite 304 and UE 102 is approximately the same as the distance (not illustrated in the figure) between the serving satellite 505 and the UE 102, and thus the timing of the satellite 304 can be considered to correspond to the timing of the PCell. The distance between the UE 102 and satellite 304 is D_{A}, and the distance between the UE 102 and satellite 306 is D_{B}, where in this example D_{B}>D_{A}. The propagation delay between the UE 102 and the satellite 304 is Δt_{A}, and the propagation delay between the UE 102 and the satellite 306 is Δt_{B}, where Δt_{B} exceeds Δt_{A} by a small amount over the duration of one subframe. For the purposes of this discussion, one can further assume that both satellites 304 and 306 emit SSB bursts at subframe 2 and subframe 12, for one subframe duration.

According to the current 3GPP specifications, the serving base station (associated with the serving satellite 505) configures the UE 102 with an inter-frequency measurement object in which the SMTC periodicity equals 10 subframes, the offset equals 2, and the duration equals 1 subframe. The existing techniques do not account for the propagation delay difference. However, with this configuration, the UE 102 cannot measure the SSB from the satellite 306, as these SSBs arrive at the UE 102 during subframe 3 and subframe 13. To make the UE 102 capable of receiving the SSB from the satellite 306, the serving base station should account for the difference between Δt_{A} and Δt_{B} when configuring the offset in the SMTC.

For the serving base station to determine the propagation delay difference accurately, the serving base station may use the geolocation of the UE 102 (e.g., a set of Global Positioning Service (GPS) coordinates or other suitable coordinates) and the ephemeris information for the satellites 304 and 306.

In the example scenario 500, after determining the geolocation of the UE 102 and the ephemeris information for the satellites 304 and 306, the serving base station configures the SMTC with the offset equaling 3 and with the duration equaling 1 or 2 subframes, so that the UE 102 can detect and measure the SSB from the satellite 306 properly. The serving base station also configures another SMTC with the offset equaling 2 and the duration equaling 1 subframe, so that the UE 102 can detect and measure the SSB from the satellite 304. As illustrated in this example, to configure the UE 102 to perform measurements on multiple measurement targets (i.e., the satellites 304 and 306) using a single measurement object, the serving base station transmits, to the UE 102, multiple offsets associated with an SMTC or multiple SMTCs within one measurement object.

Further, the serving base station may use the geolocation information of the UE 102 to configure multiple gap patterns within one measurement gap configuration, so that UE can correctly perform the inter-frequency measurements on different satellites. As illustrated in FIG. 5, the serving base station can configure two gap patterns, gap pattern A and gap pattern B, with gap pattern A covering the SSBs from the satellite 304, and with gap pattern B covering the SSBs from the satellite 306. The serving base station also can configure only one gap pattern, gap pattern C, which is longer and thus covers the SSBs from both the satellite 304 and 306.

If the serving base station configures multiple gap patterns or a gap pattern with a long gap duration based on the geolocation information of the UE 102 and the ephemeris information, the gap configuration is valid for only a short period of time due to the fast movement of the satellite. To compensate for the rapid offset change due to satellite movement, the serving base station could frequently provide the up-to-date gap configuration to UE 102.

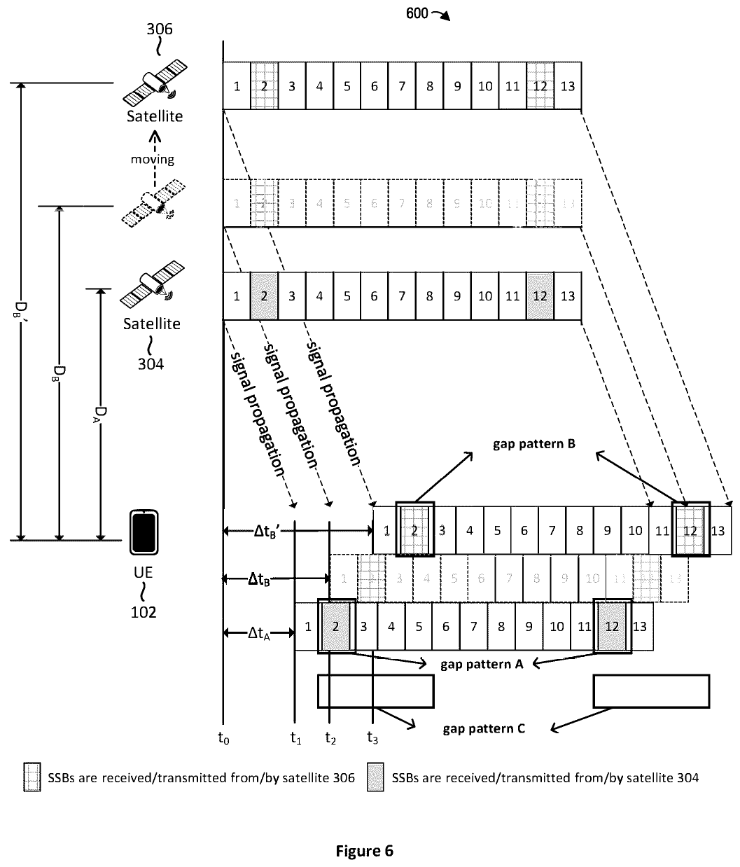

FIG. 6 illustrates the same configuration as described in FIG. 5, but at a later time. Here, the satellite 306 has moved farther away from UE 102, from the distance D_{B} to a greater distance D_{B}′, which results in an increase of the propagation delay from Δt_{B} to Δt_{B}′. As a result, the SSB bursts leaving the satellite 306 at subframe 2 and subframe 12 arrive at the UE 102 approximately at subframe 5 and subframe 15, respectively. If the network previously configured the UE 102 with the gap pattern B to measure the SSBs from the satellite 306 at subframe 3 and subframe 13, the UE 102 cannot receive these SSBs at the new time unless the gap pattern B is updated. On the other hand, if the network previously configured the UE 102 with the gap pattern C to measure the SSBs emitted from the satellites 304 and 306, the UE 102 is also unable to receive the SSBs from the satellite 306 at the new time, because the gap length of gap pattern C is no longer sufficiently large to cover the SSBs emitted by both satellites 304, 306.

To allow the UE 102 to perform the inter-frequency measurements on the SSB from the neighboring cell associated with either a quasi-Earth-fixed or an Earth-moving satellite, the base station could provide up-to-date gap patterns to the UE 102 in a very frequent manner, which results in a significant overhead, particularly considering the very large number of UEs typically operating in the connected state within satellite coverage. To address this concern and save signaling overhead, the UE 102 and the network of FIG. 1 shift or adjust parameters or values of a gap pattern, such that the serving base station and the UE 102 have a shared understanding of how the parameters of a gap pattern change. Although it is also possible to configure a gap pattern with a large duration to account for the rapid shift in timing due to satellite movement, doing so would deteriorate the throughput of the UE 102 because the UE 102 in this case cannot process any downlink or uplink traffic with the serving base station while operating in a measurement gap. Utilizing a longer gap is beneficial if the UE 102 also has a mechanism for terminating the gap earlier, or for recommending an adjustment to the gap duration to the serving base station.

Moreover, it is beneficial for the UE 102 to have not only a gap pattern configuration but also information regarding when the configuration is still valid and applicable. With this information, the UE 102 can discard, at the correct time, the gap pattern and stop applying the gaps configured by the discarded the gap pattern. This in turn reduces power consumption at the UE 102.

Next. FIG. 7A illustrates a scenario 700A in which a UE can terminate a measurement gap and inform the serving base station of the termination. The UE also can recommend a gap length to the serving base station. The discussion below refers to gNBs 104 and 104, but in general this technique can be implemented in a base station of any suitable type.

The UE 102 initially is connected to the gNB 104 via a service link of the satellite 304, and the UE 102 is in the connected state (e.g., RRC_CONNECTED). Thus, the gNB 104 is the serving base station of the UE 102, and the satellite 304 is the serving satellite of the UE 102. The serving satellite 304 is close to another satellite 306 associated with the gNB 106. The gNB 104 and gNB 106 in this scenario can communicate with each other via the Xn interface (shown in FIG. 1). In case that the Xn interface is not available, the gNB 104 and gNB 106 can communicate with each other via the NG interface (shown in FIG. 1). Using this interface (i.e., the Xn or NG interface), the serving gNB 104 exchanges 702 the satellite ephemeris information with its neighbor nodes, gNB 106, to obtain the location and movement information for the satellites (e.g., satellite 306) associated with the gNB 106.

As an alternative to the exchanging 702 of ephemeris information, the gNB 104 can acquire the satellite ephemeris information from the core network (e.g., from the AMF or OAM), or receive the relevant satellite ephemeris information at set-up or deployment and store the ephemeris information in a persistent memory. The gNBs 104 and 106 also can exchange 702 other information such as SSB configuration, for example.

The UE 102 transmits 704 UE assistance information to the gNB 104, to report the location information for the UE 102 or to report the propagation delay between the UE 102 and a relevant satellite. The UE assistance information can conform to the format specified in 3GPP TS 38.331 (v16.6.0), section 5.7.4, or alternatively the UE assistance information can be a UL DCCH message dedicated to, and defined specifically for the purpose of, reporting the UE location information or reporting the observed propagation delay between UE 102 and a satellite. By transmitting 704 the UE assistance information, the UE 102 informs the gNB 104 of the current geographic location of the UE. If the UE 102 reports 704 only the propagation delay information, the gNB 104 in some implementations autonomously derives the current geographic location of the UE 102 using the received propagation delay information.

In response to receiving 704 the UE assistance information, the gNB 104 transmits 708 an RRC reconfiguration command (e.g., RRCReconfiguration) to the UE 102. The command includes a measurement gap configuration with a gap pattern. The gNB 104 can generate the configuration of the gap pattern using the SMTC of neighbor satellite 306 and/or SMTCs of other satellites, the geographic location of the UE 102 (which the gNB 104 can receive 704 as part of the UE assistance information), and/or the satellite ephemeris information (see event 702). The gap pattern can include at least a periodicity, a gap offset, and a duration setting. The measurement configuration may further allocate an uplink resource(s) for the UE 102 to terminate a measurement gap and to inform the gNB 104 of the termination. The measurement configuration also can indicate whether the UE 102 is permitted to terminate the measurement gap (e.g., in the form of a Boolean flag).

Upon receiving 708 the gap pattern, the UE 102 performs measurements within the measurement gap according to the received gap pattern. The UE 102 then determines 713 to terminate the gap earlier (before the end of the gap duration). The UE 102 can make the determination 713 if for example the UE 102 has completed all the necessary measurements, including the measurement of the cell(s) of the satellite 306. As discussed below with reference to FIG. 7B, the UE 102 alternatively can recommend a new, preferred gap length to the gNB 104.

The UE 102 terminates the gap by transmitting 720 a gap termination request to the gNB 104. After terminating the gap, the UE 102 starts monitoring a PDCCH in slots including slots in the gap and outside the gap. If the network configured the UE 102 with a dedicated random access preamble (as part of event 708, for example), the UE 102 transmits 720 the dedicated preamble in a contention-free random access procedure, as the gap termination request signal to the gNB 104. If the network configured the UE 102 with a dedicated PUCCH (Physical Uplink Control Channel) resource(s), the UE 102 transmits 720 a signal on the PUCCH as the gap termination request signal to the gNB 104. If the network has not allocated any dedicated resources to the UE 102 but permits the UE 102 to terminate the gap earlier (e.g., via the RRC reconfiguration command of event 708), the UE 102 can initiate a contention-based random access procedure and transmit 720 an RRC message in MSG3/MSGA as the gap termination request signal to the gNB 104. The RRC message can conform to the format of the existing UE assistance information specified in 3GPP TS 38.331 (v16.7.0 or later versions), section 5.7.4, or the RRC message can be a message specifically defined for, and dedicated to, conveying a gap termination request. In some implementations, the UE 102 also recommends one or more configurations of the gap pattern (e.g., the gap length) in the UL DCCH message.

The gNB 104 terminates 722 upon receiving 720 the gap termination request. After terminating 722 the gap, the gNB 104 starts scheduling and transmitting 724 DL traffic to the UE 102 via the satellite 304. For example, after terminating the gap, the gNB 104 can transmit 724 to the UE 102 a DCI, in a slot within a remaining time duration of the gap. The UE 102 thus can efficiently communicate data with the gNB 104. Upon receiving 724 any DL traffic (e.g., the DCI) during the gap period, the UE 102 can infer that the gNB 104 has successfully received the gap termination request.

The gNB 104 then can provide 726 an updated measurement gap configuration to the UE 102. The updated measurement gap configuration can include an updated gap pattern from. In some implementations, the gNB 104 can generate the updated measurement gap configuration based on the UE assistance information. After receiving 726 the updated measurement gap configuration, the UE 102 starts using the gap according to the updated gap pattern, and performs 730 inter-frequency measurements.

In this example, after the gap duration ends 740, the UE 102 can determine that the triggering event for measurement reporting has occurred (e.g., the signal strength of the satellite 306 is now greater than the signal strength of the satellite 304 by more than a threshold value) for at least a duration indicated in the ‘timeToTrigger’ parameter. The UE 102 accordingly transmits 760 a measurement report to the gNB 104. The UE 102 can format the measurement report according to the reporting configuration received 726 earlier.

Upon receiving 760 the measurement report, the gNB 104 can determine to initiate 770 a handover of the UE 102 to the gNB 106. The gNB 104 then can participate in a handover procedure 780 that includes such steps as (i) sending a HANDOVER REQUEST message to the gNB 106, (ii) receiving a HANDOVER REQUEST ACKNOWLEDGE message from the gNB 106, and (iii) transmitting an RRC reconfiguration command including a reconfiguration WithSync IE to the UE 102. Upon receiving the RRC reconfiguration command with the reconfiguration WithSync IE, the UE 102 can initiate the procedure for connecting to the gNB 106, which can include (i) synchronizing with the gNB 106 and obtaining the PBCH from the gNB 106, (ii) performing a contention-free random access (CFRA) procedure by sending a pre-allocated preamble to the gNB 106, and (iii) sending the an RRC reconfiguration complete message (e.g., RRCReconfigurationComplete) to the gNB 106 using an uplink grant from the CFRA procedure.

In some implementations, the satellite 306 can connect to the gNB 104 instead of the gNB 106. In such cases, the HANDOVER REQUEST message and HANDOVER REQUEST ACKNOWLEDGE message can be omitted

Now referring to FIG. 7B, a scenario 700B is generally similar to the scenario 700A of FIG. 7A. Here, however, the UE 102 determines 712 that it should recommend a new, preferred configuration(s) of the gap pattern to the gNB 104. In some implementations, the UE 102 waits until the gap duration ends 719 before transmitting 712 UE assistance information in a time slot outside the gap. In other implementations, the UE 102 initiates a random access procedure to transmit 721 the UE assistance information to the gNB 104, without waiting for the gap period to elapse, similar to transmitting 720 a gap termination request in the scenario 700A.

The UE assistance information in this scenario includes one or more configurations of the gap pattern (e.g., the gap length, the gap offset, or the gap periodicity) the UE 102 recommends to the gNB 104. The UE 102 can recommend the configurations of a gap pattern based on one or any combinations of the following factors (i) t the current geographic location of the UE, (ii) ephemeris information, (iii) the distance/propagation delay between the UE 102 and the satellite 304, (iv) the distance/propagation delay between the UE 102 and the satellite 306, or (v) the distance/propagation delay between the UE 102 and other satellites. In some implementations, the UE assistance information is an RRC message specifically defined for, and dedicated to, conveying a gap configuration information. In another implementation, the UE assistance has the format of the UEAssistanceInformation message specified in 3GPP TS 38.331 (v16.7.0), section 5.7.4. When the gap the UE 102 recommended begins, the UE 102 starts performing measurements in accordance with the new gap. When performing measurements using time slots in the new gap, the UE can stop monitoring the PDCCH.

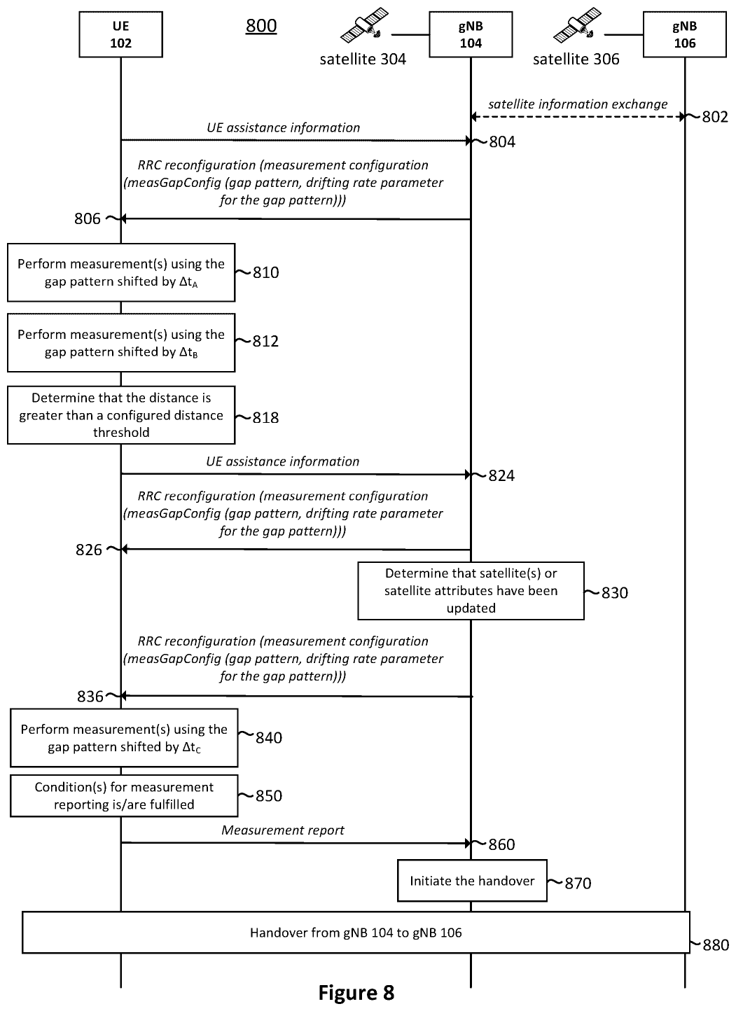

Next. FIG. 8 illustrates a scenario 800 in which a UE operating in the connected state automatically updates the gap pattern without requiring that the network repeatedly provide signaling for the update. Similar to the scenario 702, the UE 102 initially operates in the connected state, with the gNB 104 operates as the serving base station. Events 802 and 804 are similar to events 702 and 704, respectively.

In response to receiving 804 the UE assistance information, the gNB 104 transmits 806 an RRC reconfiguration command (e.g., RRCReconfiguration) to the UE 102. The command includes a measurement configuration, which in turn includes a measurement gap configuration including a gap pattern. The gNB 104 can configure the gap patter based on the SMTC of the satellite 306 and/or the SMTCs of other satellites. The gNB 104 can use the satellite ephemeris information obtained earlier.

The gap pattern can include periodicity, a gap offset, and a duration setting. The gap pattern or the measurement gap configuration also can include a drifting configuration instructing UE 102 how to adjust/shift the gap offset of the gap pattern as a function time. The drifting configuration may include a drifting rate parameter D₃₀₆, which indicates the amount of time shift for a gap offset per unit of time. In an example implementation, the UE 102 multiplies the drifting rate parameter D₃₀₆ by the time elapsed (T_{elapsed}) since the time the UE 102 last received a measurement configuration to obtain a drift result (i.e., D₃₀₆*T_{elapsed}), and adds the drift result to the initial time offset (offsetᵢₙᵢₜ) of the gap pattern to obtain an actual time offset for the gap (i.e., offset_{actual}=offsetᵢₙᵢₜ+D₃₀₆*T_{elapsed}). The UE 102 then applies the actual gap offset (offset_{actual}) to determine the timing of the gap for conducting the inter-frequency measurement. When formatting the measurement configuration, the gNB 104 also can place the drifting configuration outside the gap patter element but inside the measurement gap configuration, if the drifting rate configuration is applicable to all the gap patterns within the measurement gap configuration.

When the offset_{actual} value the UE 102 determines upon receiving 706 the RRC reconfiguration message is not an integer, the UE 102 can round the value up or down to a nearest integer. Alternatively, the UE 102 can round the non-integer offset_{actual} down to a nearest integer, and then increase the duration setting of the SMTC by one subframe. The drifting rate parameter D₃₀₆ could have a positive value or or negative value, depending on whether satellite 306 is moving closer toward the UE 102 (in which case D₃₀₆ is negative) or farther away from the UE 102 (in which case D₃₀₆ is positive). The drifting configuration may contain more than one drifting parameter if the drifting/shifting calculation is not a linear function of the time elapsed (e.g., offset_{actual}=offsetᵢₙᵢₜ+D_{306A}*T_{elapsed}²+D_{306B}*T_{elapsed}+constant value). To facilitate the calculation of the elapsed time at the UE 102, the gNB 104 can further provide a reference timing (e.g., a UTC timing or a system frame number plus a subframe number) along with the measurement gap configuration to the UE 102. When the RRC reconfiguration of event 706 includes the reference timing, t_{ref}, the UE 102 can obtain the elapsed time based on the calculation t_{elapsed}=t_{now}−t_{ref}, where t_{now} denotes the current time on the UE side.

After receiving 806 the measurement configuration, the UE 102 performs 810 the inter-frequency measurement on the SSB from the satellite 306. Assuming the time difference between events 706 and 710 is t_{A}, the UE 102 conducts the SSB measurement using the gaps in which the UE 102 shifts the gap offset by Δt_{A}, where Δt_{A}=D₃₀₆*t_{A} (assuming the drifting function is a linear function of the time elapsed). The UE 102 then leaves the gap at the end of the gap period.

Subsequently to performing 810 the measurement(s), the UE 102 uses 812 another gap. Assuming the time difference between events 706 and 712 is t_{B} (t_{B}>t_{A}), the UE 102 uses the gaps based on the gap pattern with the gap offset shifted by Δt_{B}, where Δt_{B}=D₃₀₆*t_{B} (assuming the drifting function is a linear function of the time elapsed), and then leaves the gap at the end of the gap period.

Subsequently to using 810 and 812 the gaps, the UE 102 detects 818 that it has moved a distance greater than a certain distance threshold value, which the UE 102 can receive as part of a measurement configuration from the gNB 104, in a system information via a broadcast from the gNB 104, or from the memory as a hardcoded value consistent with a 3GPP specification. The UE 102 then transmits 724 UE assistance information to the gNB 104, to report the current location of the UE 102 or to report the propagation delay between the UE 102 and a relevant satellite (which can be any satellite the UE 102 observes at its current location).

In response to receiving 824 the UE assistance information, the gNB 104 can transmit 826, to the UE 102, an RRC reconfiguration command including an updated measurement configuration. The updated measurement configuration can include an updated measurement gap configuration with an updated gap pattern. The gNB 104 can update the gap pattern (i.e., the periodicity, the offsetᵢₙᵢₜ, the duration, and the drifting configuration) based on the SMTC of the satellite 306 and of other satellites in some cases, the new UE geographic location reported/determined received 724 from the UE, the satellite ephemeris information obtained during the exchange 802 or earlier, and the new satellite location of the satellite 304 and/or satellite 306.

The gNB 104 detects 833 that the satellite 304 and/or the satellite 306 has moved to a new location, and that the gap pattern the gNB 730 previously provided 726 to the UE 102 is longer applicable. The gNB 104 then transmits 736, to the UE 102, another RRC reconfiguration command including an updated measurement configuration with an updated measurement gap configuration, which in turn includes an updated gap pattern. The gNB 104 can update the gap pattern in a manner similar to the example above.

Upon receiving 836 the updated gap measurement configuration, the UE 102 can perform inter-frequency measurements 840 on the SSB from the by satellite 306. Assuming the time difference between events 836 and 840 is t_{C}, the UE 102 uses the gaps based on the gap pattern in which the UE 102 shifts the fap offset by Δt_{C}, where Δt_{C}=D₃₀₆*t_{C} (assuming the drifting function is a linear function of the time elapsed). The UE 102 then leaves the gap at the end of the gap period.

Events 850, 860, 870, and 880 are similar to events 750, 760, 770, and 780 discussed above.

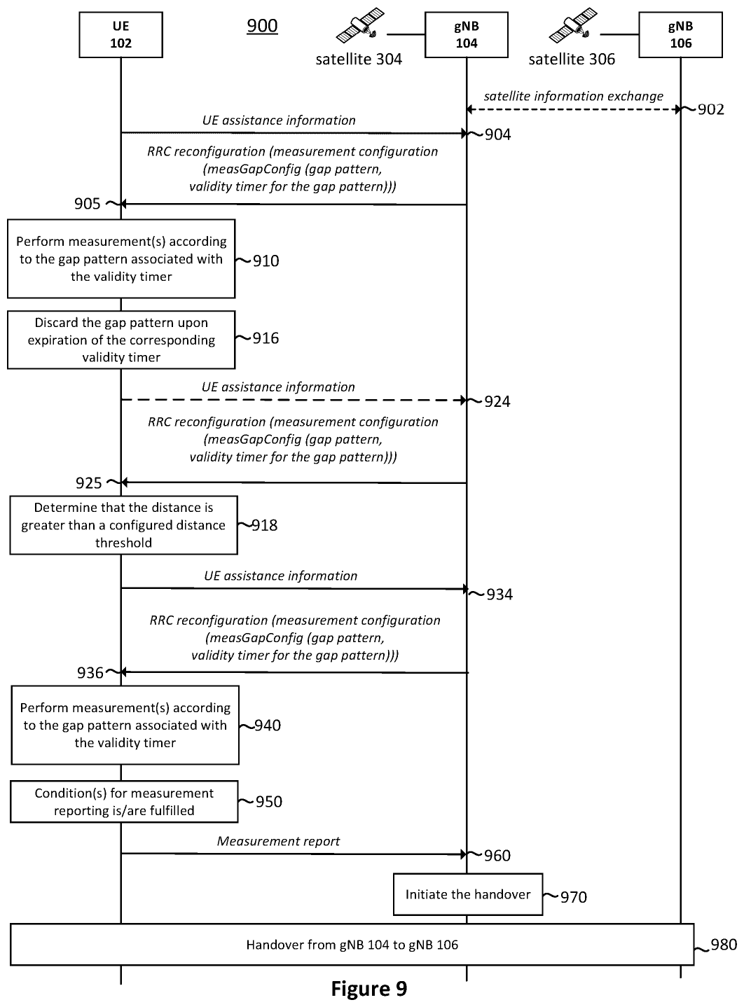

Next, FIG. 9 illustrates a scenario 900 in which a base station provides a validity timer to a UE rather than a drifting parameter of FIG. 8, so that the UE can discard the gap pattern upon timer expiration or countdown to zero.

Similar to the scenario 800, the UE 102 initially operates in the connected state, with the gNB 104 and the satellite 304 operating as the serving base station and the serving satellite, respectively; the satellites 304 and 306 are relatively close; and the gNBs 104 and 106 can communicate via an Xn interface. Event 802 is similar to event 702, and event 804 is similar to event 704.

The gNB 104 transmits 805 an RRC reconfiguration command to the UE 102. The RRC reconfiguration command is similar to the RRC reconfiguration command of event 704, but according to this implementation the gNB 104 includes in measurement gap configuration a validity timer T_{valid_i} which the UE 102 is to activate (i.e., start running) upon receiving 805 the measurement configuration. While T_{valid_i} is running, the corresponding gap pattern remains valid, and the UE 102 can conduct the measurement according to this gap pattern. However, when T_{valid_i} expires, the UE 102 is to discard the corresponding gap pattern. Each gap pattern in the measurement gap configuration can be associated with an individual validity timer (which the gNB 104 can specify along with the gap pattern) or a shared validity timer (which the gNB 104 can specify along with the measurement gap configuration).

Event 910 is generally similar to the event 810, except that the UE 102 uses a gap pattern to perform 910 the measurement(s) when the timer associated with the gap pattern is still running.

The UE 102 discards or releases 916 the gap pattern upon expiration of T_{valid_i}. After discarding or releasing the SMTC, the UE 120 can transmit 924 UE assistance information to the gNB 104, similar to event 824 discussed previously. Upon receiving 924 the UE assistance information, the gNB 104 transmits 925 an RRC reconfiguration command with an updated measurement configuration and a new validity timer. The updated measurement gap configuration can include an updated gap pattern.

Events 918 and 934 are similar to events 818 and 824, respectively. The gNB 104 then transmits 936 an RRC reconfiguration command to the UE 102, in which the gNB 104 can include an updated measurement gap configuration with an updated gap pattern, and an updated validity timer for the updated gap pattern. The UE 102 performs 940 the measurement(s) according to the updated gap pattern upon ascertaining that the updated timer associated with the updated gap pattern is running. Events 950, 960, 970, and 980 are similar to events 850, 860, 870, and 880 discussed above.

In some implementations, the gNB 104 uses both the drifting parameter technique of FIG. 8 and the invalidity timer technique of FIG. 9. In particular, the gNB 104 includes both the drifting parameter and the value of the validity timer in the measurement gap configuration. Thus, each gap pattern in the measurement gap configuration can be associated with an individual validity timer or a common validity timer, and also can include a drifting configuration instructing the UE 102 how to update the gap pattern. While the validity timer is running, the UE 102 can perform measurement(s) according to the corresponding gap pattern including the drifting configuration. After the validity timer expires, the UE 102 discards the corresponding gap pattern setting including the drifting configuration.

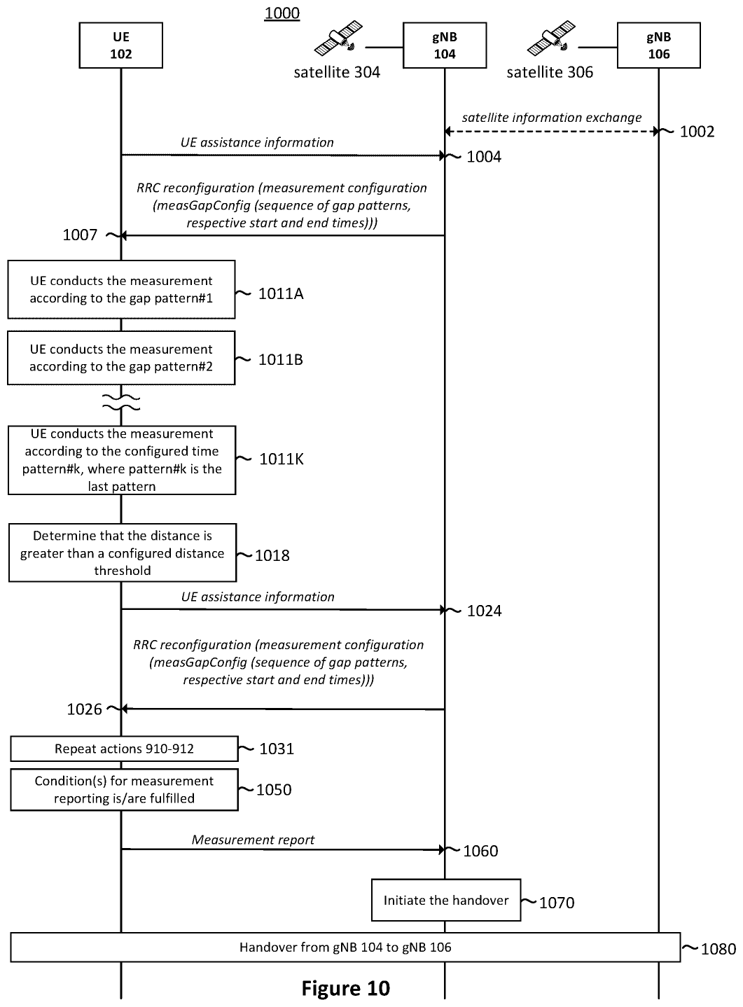

In the scenario 1000 illustrated in FIG. 10, a base station implements yet another technique. According to this approach, the base station provides a UE with a measurement gap configuration that includes multiple gap patterns. Each gap pattern is applicable for a certain period of time that does not overlap with the period of validity of any other gap patterns. The UE applies the gap patterns in sequence, traversing the set as a list.

Events 1002, 1004, 1018, 1024, 1050, 1060, 1070, and 1080 are similar to events 902, 904, 918, 924, 950, 960, 970, and 980, respectively. In response to receiving 1004 the UE assistance information, the gNB 104 transmits 1007 an RRC reconfiguration command generally similar to the RRC reconfiguration command of events 806 and 905, but here the gNB 104 generates a measurement configuration that includes a measurement gap configuration with a set of gap patterns corresponding to different time periods. Each gap pattern in the set is associated with a start time at which the UE 102 is to start applying the gap pattern, and with an end time at which the UE 102 is to discard or release the gap pattern. Each gap pattern in the set can include a periodicity, a gap offset, and a duration setting. The gNB 104 can determine the gap offset setting based on the SMTCs, the estimated distances between the UE 102 and the satellites, etc.

Upon receiving 1007 the measurement configuration, the UE 102 performs 1011A measurement(s) according to the first gap pattern (i.e., gap pattern 1) in the SMTC set. The UE 102 uses 1011A the first gap pattern within the period delimited by the start time and the end time associated with the first gap pattern. The UE 102 then performs 1011B measurement(s) according to the second gap pattern (i.e., gap pattern 2) in the set, again within the corresponding time limits. In this manner, the UE 102 traverses the list of the gap patterns until the UE 102 performs 1011K the last measurement(s) using the last gap pattern within the period delimited by the start time and the end time associated with the last gap pattern.

In response to receiving 1024 UE assistance information, the gNB 104 can transmit 1027 an RRC reconfiguration command with an updated gap measurement configuration and an updated sequence or listing of gap patterns. The UE 102 repeats 1031 the steps 1011A-K according to the new set of gap patterns and performs a handover when the measurement report contains measurements that trigger a handover.

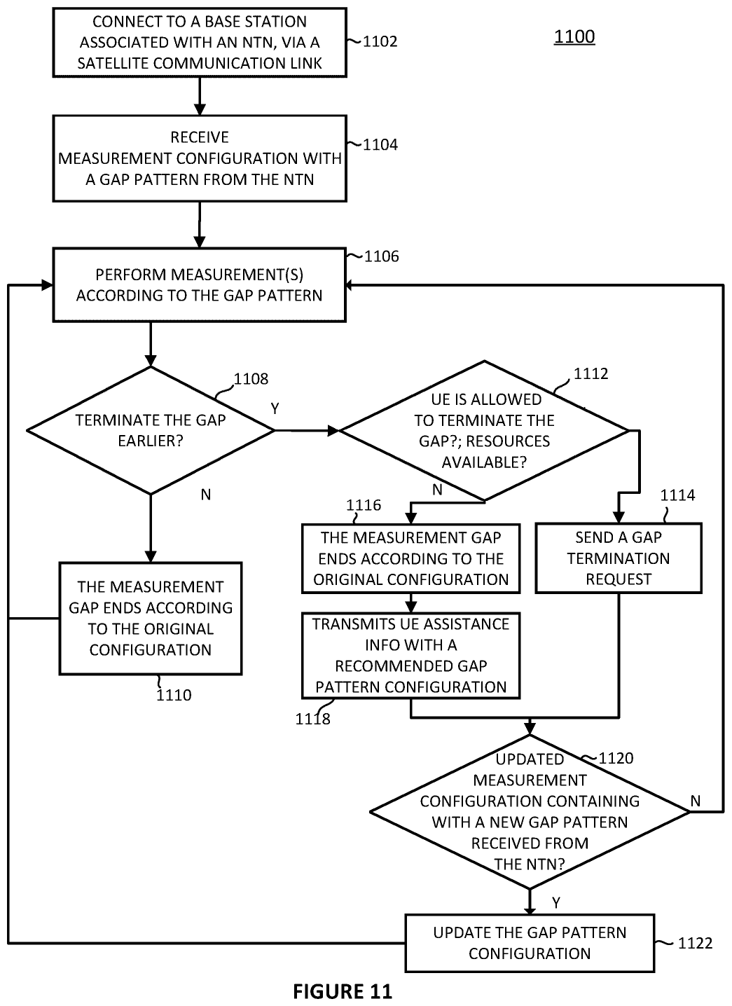

Next, several example methods that can be implemented in one or more devices of FIG. 1 are discussed with reference to FIGS. 11-13. Each of these methods can be implemented as a set of software instructions stored on a non-transitory computer-readable medium (e.g., a memory chip) and executable by one or more processors.

Referring first to FIG. 11, a UE such as the UE 102 can implement a method 1100 to manage gap measurement configuration.

At block 1102, the UE establishes an RRC connection with the gNB operating in an NTN via the satellite communication. At block 1104, after connecting to the gNB, the UE receives a measurement configuration containing at least a gap pattern from the connected gNB, where the gap pattern can be included in a measurement gap configuration of the measurement configuration. The gap pattern includes multiple parameters such as gap periodicity, gap length, and gap offset.

At block 1106, the UE uses the measurement gap for conducting inter-frequency measurements according to the received gap pattern. Then, at block 1108, the UE determines whether it should terminate the gap earlier than the configured gap duration. The UE may determine to terminate the gap earlier upon completing all of the all required inter-frequency measurements significantly before the gap ends (e.g., earlier than a threshold amount of time). If the UE determines that it should not terminate the gap earlier, the flow proceeds to block 1110, where the UE leaves the gap according to the configured gap length. The flow the returns to block 1106 for using another gap based on the gap pattern configuration.

If the UE 102 determines to terminate the gap earlier at block 1108, the UE at block 1112 further check whether the network previously configured the UE with resources to inform the gNB of the termination of the gap, and whether the networks allows the UE to terminate the gap early. If the UE has the appropriate configuration and a resources for notifying the gNB of the termination of the gap (and if the UE has the permission to terminate a gap), the UE terminates the gap and informs the gNB of this termination by transmitting a gap termination request to the gNB. The gap termination request may be in the form of a dedicated preamble transmitted by the UE in a contention-free random access procedure, a PUCCH resource transmitted by the UE, or an UL DCCH message transmitted by the UE in a contention-based random access procedure, depending on whether the network configured the UE h with the resource for informing the termination of a gap, and which resources the UE has.

On the other hand, if the network has not configured the UE with the resource for informing the termination of a gap, or the UE lacks permission is to terminate the gap, the flow proceeds to block 1116. The UE thus leaves the current gap based on the gap pattern configuration. At block 1118, after the UE has left the gap and has re-synchronized with its serving gNB, the UE transmits UE assistance information containing the recommended configuration(s) of the gap pattern to the gNB. The UE assistance information can be defined specifically for conveying this type of information, or the UE assistance information can conform to the existing definition of UE assistance information specified in 3GPP TS 38.331 (v16.7.0), section 5.7.4.

After the UE sends a gap termination request or a recommended configuration(s) of a gap pattern to the gNB at block 1114 or block 1118, the flow proceeds to block 1120, where the UE checks whether it received, from the gNB, an updated measurement configuration including at least a gap pattern gNB. If the UE has not received an update measurement configuration containing an updated gap pattern, the UE continues to use the original or existing gap pattern configuration and uses the next gap accordingly at block 1106. Otherwise, the UE updates the gap pattern at block 1122 according to the received update, and then uses the next gap based on the updated gap pattern configuration at block 1106.

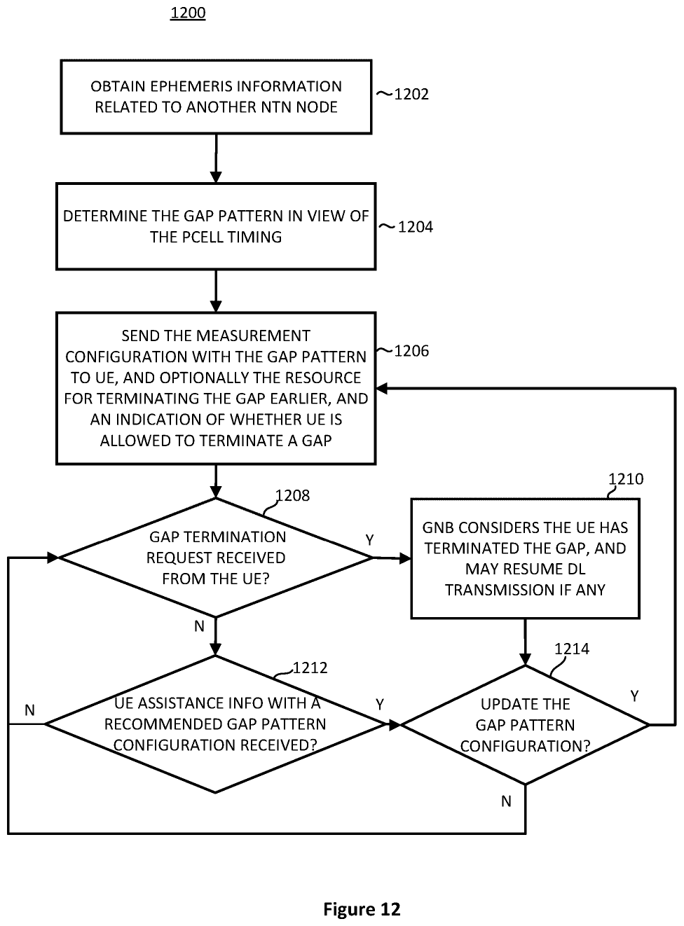

FIG. 12 illustrates an example method 1200 for providing a UE with an updated measurement configuration, which can be implemented in an NTN node such as the gNB 104 or 106.

At block 1202, the gNB obtains the ephemeris information from the 5GC via NGC or from its neighbor gNBs via Xn, where the ephemeris information includes the location information and the movement information (e.g., the moving direction and moving speed) of every satellite of interest. The gNB may also receive, from the UE, the information the gNB uses at block 1202 to determine the geographic location of the UE.

At block 1204, the gNB determines a gap pattern for the UE to use measurement gaps and conduct inter-frequency measurements(s) on the SSB transmitted by a measurement target, based on the PCell timing. The gNB can place the gap pattern(s) can in the measurement gap configuration of the measurement configuration. The gap pattern includes multiple parameters such as gap periodicity, gap length, and gap offset.

At block 1206, after determining the gap pattern for the UE, the gNB transmits the measurement configuration with the determined gap pattern to the UE. The gNB can include in the measurement configuration a resource configuration which the UE can use to inform the gNB of the termination of a measurement gap. The resource the gNB configures for the UE can be a dedicated preamble for performing a contention-free random access procedure, or a PUCCH resource for example. In some implementations, instead of including a resource configuration in the measurement configuration, the gNB includes a certain indicator in the measurement configuration to indicate to the UE whether it is allowed to terminate the measurement gap earlier. The UE can interpret the absence the indicator as ‘not allowed’.

After transmitting the measurement configuration to the UE, the flow proceeds to block 1208, and the gNB determines whether it has received a gap termination request from the UE during an on-going measurement gap. This request is possible when the gNB has configured the UE with a resource for informing the termination of a gap, and/or it has indicated to the UE that the UE is allowed to terminate the gap earlier. If the gNB has received a gap termination request from the UE, the gNB considers the current measurement gap to be successfully terminated and resumes the DL transmission (when data is available) toward the UE. The flow then proceeds to block 1214.

If, however, the gNB has not received a gap termination request from the UE during an on-going measurement gap, the gNB awaits the end of the gap and checks, at block 1212, whether the gNB has received UE assistance information including a recommended gap pattern configuration(s). If the gNB has not received the UE assistance information from the UE, flow returns to the decision block 1208. Otherwise, the flow returns to the next decision block 1214.

At block 1214, the gNB determines whether to modify/update the configuration(s) in the gap patter(s) for the UE. If the gNB determines to modify/update the gap pattern configuration(s), the flow returns to block 1206 and sends an updated measurement configuration including the updated gap pattern configuration(s) to the UE. Otherwise, the flow returns to block 1208.

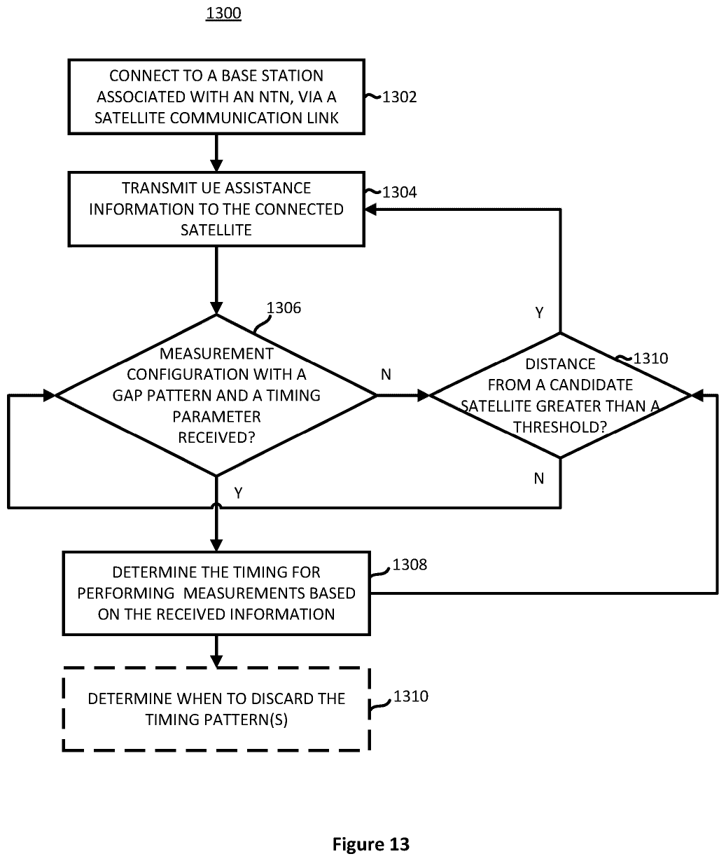

Next, FIG. 13 illustrates an example method 1300 for managing a gap pattern, which can be implemented in a UE operating in the connected state. The method 1300 begins at block 1302, where the UE establishes an RRC connection with the gNB operating in an NTN. At block 1304, the UE transmits, to the gNB, UE assistance information with the UE geographic location information or other information that can assist the gNB in determining the geographic location of the UE. This information can include for example an indication of a propagation delay between the UE and the serving satellite as well as indications of propagation delays between the UE and neighboring satellites.

At block 1306, the UE determines whether it has received a measurement configuration containing at least a gap pattern and a time-related parameter associated with the gap pattern from the connected gNB. The gap pattern can reside in the measurement gap configuration of a measurement configuration, and the time-related parameter can be the drifting rate parameter(s) discussed with reference to FIG. 8, the validity timer discussed with reference to FIG. 9, or the start and end times discussed with reference to FIG. 10. If the UE has received the measurement configuration containing at least a time pattern and the associated time-related parameter from the connected gNB, the flow proceeds to block 1308. Otherwise, the flow proceeds to block 1310.

At block 1308, the UE determines when to use measurement gaps and/or when to discard the gap pattern(s), based on the gap pattern(s), the time-related parameter(s) configured in the measurement gap configuration, and the time elapsed since receiving the measurement configuration. When the measurement gap configuration contains a drifting rate parameter as the time-related parameter, the UE can use the measurement gaps based on the gap pattern shifted by the product of the drifting rate parameter and the time elapsed. When the measurement gap configuration contains a validity timer as the time-related parameter, the UE can use the measurement gaps based on the gap pattern only if the associated validity timer is still running (validity timer is considered as running only if the time elapsed is smaller than the value of the validity timer). When the measurement gap configuration contains a start time and an end time as the time-related parameter, the UE can use sets of gaps sequentially based on the sequence of gap patterns sorted by the start/end time pair (e.g., the UE can apply a gap pattern if the time elapsed makes the current time of the UE fall within the time spanned by the start time and end time of that gap pattern). After the UE has completed block 1308, the flow proceeds to decision block 1310.

At block 1310, the UE determines whether it has moved a distance that is greater than a distance threshold. This distance can be a predetermined, fixed value or a value received from the gNB. If the UE has moved a distance greater than the distance threshold, the flow proceeds to block 1304; otherwise, the flow proceeds to block 1306.

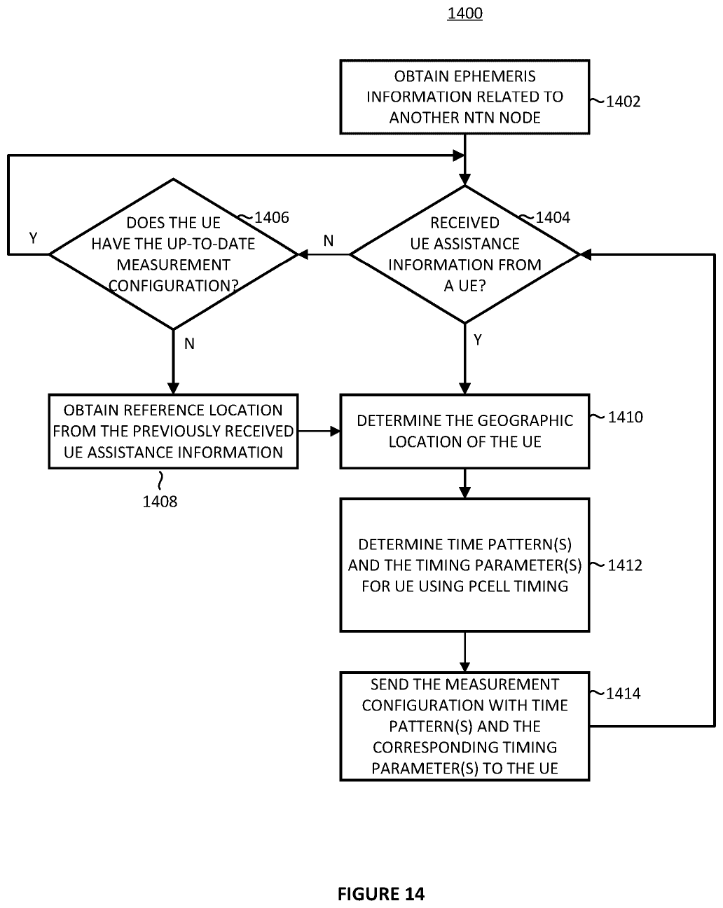

Finally, FIG. 14 illustrates an example method 1400 for providing a UE with an updated measurement configuration. The method 1400 can be implemented in an NTN node such as the gNB 104 or gNB 106 for example. At block 1402, the gNB obtains the ephemeris information from the 5GC via NGC or from its neighbor gNBs via Xn. As discussed above, the ephemeris information can include the location information and the movement information (e.g., the moving direction and moving speed) of every satellite of interest.

At block 1410, the gNB determines whether it has received UE assistance information transmitted from the UE. If the gNB has received UE assistance information from the UE, it can determine the geographic location of the UE with the already-available information, and the flow proceeds to block 1410. Otherwise, the flow proceeds to block 1408 via block 1406 (because the UE does not have the up-to-date measurement configuration at this stage), so that the gNB can determine the geographic location of the UE based on a reference location at block 1408.

At block 1410, the gNB obtains the geographic location of the UE directly without any further processing, if the received UE assistance information contains the geographic location information for the UE. However, if the received UE assistance information does not contain the UE geographic location information, the gNB determines the geographic location of the UE from other information carried in the UE assistance information, such as the propagation delay between the serving satellite and the UE, and/or the propagation delay between the measurement target and the UE. After the gNB obtains the geographic location of the UE, the flow proceeds to block 1412.

At block 1412, the gNB determines at least a gap pattern and a time-related parameter associated with the gap pattern, which the UE can use with measurement gaps to conduct the inter-frequency measurement on the SSB transmitted by a measurement target, based on the PCell timing. The time-related parameter(s) can correspond to any of the techniques discussed above with reference to FIGS. 8-10. Next, at block 1414, the gNB transmits the gap pattern(s) and the time-related parameter(s) to the UE. The gNB also can provide the UE with a reference time (e.g., a UTC timing or a system frame number plus a subframe number).

After the gNB transmits the gap pattern(s) and the time-related parameter(s) to the UE at block 1414, the flow returns to block 1404. The gNB awaits further UE assistance information. If the gNB receives further UE assistance, the flow proceeds to block 1410, and then to blocks 1412 and 1414. However, if no further UE assistance information is available, the flow proceeds to block 1406 to determine whether the measurement gap configuration (i.e., the gap pattern and the time-related parameter) has been out-of-date due to the satellite movement. If the measurement gap configuration has been out-of-date, the gNB determines at block 1408 the geographic location of the UE and then proceeds to block 1410 for generating the new gap pattern(s) and the new time-related parameter(s).

The list of examples below reflects a variety of the embodiments explicitly contemplated herein.

Example 1 is a method for synchronization signal measurement implemented in a UE. The method comprises receiving, by the UE from an NTN, a measurement configuration that indicates a timing pattern for inter-frequency measurement, the timing pattern having a measurement gap of a certain duration; receiving, by UE from the NTN, a synchronization signal during the measurement gap in accordance with the timing pattern; performing, by the UE, a measurement of the synchronization signal; and transmitting, by the UE to the NTN, an indication related to the measurement gap.

Example 2 is the method of example 1, wherein transmitting the indication includes transmitting, to the NTN and prior to an end of the measurement gap, a request to terminate the measurement gap.

Example 3 is the method of example 2, wherein transmitting the request includes transmitting a dedicated preamble during a RACH procedure.

Example 3 is the method of example 2, wherein transmitting the request includes transmitting a signal on a dedicated PUCCH.

Example 5 is the method of example 2, wherein transmitting the request includes performing a contention-based RACH procedure to acquire a resource for transmitting a Radio Resource Control (RRC) message; and transmitting, using the resource, the RRC message including the request.

Example 5 is the method of any of examples 2-5, further comprising monitoring, by the processing hardware, a Physical Downlink Control Channel (PDCCH) of a serving NTN node in a timeslot within a remainder of the measurement gap.

Example 7 is the method of any of examples 2-6, further comprising receiving, from the NTN and within a remainder of the measurement gap, downlink user data.

Example 8 is the method of any of examples 2-7, wherein transmitting the request is in response to determining that the UE has completed a sufficient amount of the measurement.

Example 9 is the method of example 1, wherein transmitting the indication includes transmitting, to the NTN and after the measurement gap completes, a recommendation for setting a new measurement gap.

Example 10 is the method of example 9, wherein the recommendation includes one or more of: (i) a length of the measurement gap, (ii) an offset of the measurement gap in a frame, or (iii) periodicity of the measurement gap.

Example 11 is the method of example 9 or 10, wherein transmitting the recommendation includes transmitting a UE assistance information message.

Example 12 is the method of any of examples 9-11, further comprising: receiving, from the NTN and in response to the recommendation, an updated timing pattern.

Example 13 is the method of any of the preceding examples, further comprising receiving, from the NTN, an indication of whether the UE is allowed to transmit the indication related to the measurement gap.

Example 14 is the method of any of the preceding examples, further comprising: receiving, from the NTN, an uplink resource for transmitting the indication related to the measurement gap.

Example 15 is the method of any of the preceding examples, wherein: the measurement configuration is received from a first satellite, and the synchronization signal is received from a second satellite.

Example 16 is the method of example 15, wherein the synchronization signal is a first synchronization signal; the method further comprising receiving, in accordance with the timing pattern, a second synchronization signal from a third satellite.

Example 17 is the method of any of the preceding examples, further comprising: receiving, from the NTN, a timing parameter related to a change in timing alignment between the UE and a node of the NTN that generates the synchronization signal; wherein performing the measurement of the synchronization signal is based in part on the timing parameter.

Example 18 is the method of example 17, wherein the timing parameter specifies a drifting function that indicates an amount by which the timing alignment shifts, per unit of time.

Example 19 is the method of example 17, wherein the timing parameter indicates a validity time during which the timing pattern remains valid.

Example 20 is a UE comprising processing hardware and configured to implement a method of any of the preceding claims.

Example 21 is a method for configuring synchronization signal measurement in a user equipment (UE), the method implemented in a serving non-terrestrial network (NTN) node and comprising: transmitting, by processing hardware to a UE, a measurement configuration that indicates a timing pattern for inter-frequency measurement at the UE, the timing pattern having a measurement gap of a certain duration; receiving, by the processing hardware from the UE, an indication related to the measurement gap; and modifying, by the processing hardware, the timing pattern in accordance with the received indication.

Example 22 is the method of example 1, wherein transmitting the indication includes receiving, from the UE and prior to an end of the measurement gap, a request to terminate the measurement gap.

Example 23 is the method of example 22, wherein receiving the request includes receiving a dedicated preamble during a contention-free random access procedure (RACH).

Example 24 is the method of example 22, wherein receiving the request includes receiving a signal on a dedicated Physical Uplink Control Channel (PUCCH).

Example 25 is the method of example 22, wherein receiving the request includes providing, to the UE and during a contention-based RACH procedure, a resource for transmitting a Radio Resource Control (RRC) message; and receiving, over the resource, a RRC message including the request.

Example 26 is the method of any of examples 22-25, further comprising transmitting, by the processing hardware, a Downlink Control Information (DCI) on a Physical Downlink Control Channel (PDCCH) in a timeslot within a remainder of the measurement gap.

Example 27 is the method of methods 22-26, further comprising transmitting, within a remainder of the measurement gap, downlink user data.

Example 28 is the method of example 21, wherein receiving the indication includes receiving, after the measurement gap completes, a recommendation for setting a new measurement gap.

Example 29 is the method of example 28, wherein the recommendation includes one or more of: (i) a length of the measurement gap, (ii) an offset of the measurement gap in a frame, or (iii) periodicity of the measurement gap.

Example 30 is the method of example claim 28 or 29, wherein receiving the recommendation includes receiving a UE assistance information message.

Example 31 is the method of any of examples 28-30, further comprising transmitting, to the UE and in response to the recommendation, an updated timing pattern.

Example 32 is the method of any of examples 21-30, further comprising transmitting, to the UE, an indication of whether the UE is allowed to transmit the indication related to the measurement gap.

Example 33 is the method of any examples 21-32, further comprising transmitting, to the UE, an uplink resource for transmitting the indication related to the measurement gap.

Example 34 is an NTN node comprising processing hardware and configured to implement a method of any of examples 21-33.

The following description may be applied to the description above.

In some implementations, “message” is used and can be replaced by “information element (IE)”. In some implementations, “IE” is used and can be replaced by “field”. In some implementations, “configuration” can be replaced by “configurations” or the configuration parameters.

A user device in which the techniques of this disclosure can be implemented (e.g., the UE 102) can be any suitable device capable of wireless communications such as a smartphone, a tablet computer, a laptop computer, a mobile gaming console, a point-of-sale (POS) terminal, a health monitoring device, a drone, a camera, a media-streaming dongle or another personal media device, a wearable device such as a smartwatch, a wireless hotspot, a femtocell, or a broadband router. Further, the user device in some cases may be embedded in an electronic system such as the head unit of a vehicle or an advanced driver assistance system (ADAS). Still further, the user device can operate as an internet-of-things (IoT) device or a mobile-internet device (MID). Depending on the type, the user device can include one or more general-purpose processors, a computer-readable memory, a user interface, one or more network interfaces, one or more sensors, etc.

Certain embodiments are described in this disclosure as including logic or a number of components or modules. Modules may can be software modules (e.g., code, or machine-readable instructions stored on non-transitory machine-readable medium) or hardware modules. A hardware module is a tangible unit capable of performing certain operations and may be configured or arranged in a certain manner. A hardware module can comprise dedicated circuitry or logic that is permanently configured (e.g., as a special-purpose processor, such as a field programmable gate array (FPGA) or an application-specific integrated circuit (ASIC), a digital signal processor (DSP), etc.) to perform certain operations. A hardware module may also comprise programmable logic or circuitry (e.g., as encompassed within a general-purpose processor or other programmable processor) that is temporarily configured by software to perform certain operations. The decision to implement a hardware module in dedicated and permanently configured circuitry, or in temporarily configured circuitry (e.g., configured by software) may be driven by cost and time considerations.

When implemented in software, the techniques can be provided as part of the operating system, a library used by multiple applications, a particular software application, etc. The software can be executed by one or more general-purpose processors or one or more special-purpose processors.

1. A method for synchronization signal measurement implemented in a user equipment, the method comprising:
receiving, by the UE from a non-terrestrial network, a measurement configuration that indicates a timing pattern for inter-frequency measurement, the timing pattern having a measurement gap of a certain duration;
receiving, by the UE from the NTN, a synchronization signal during the measurement gap in accordance with the timing pattern;
performing, by the UE, a measurement of the synchronization signal; and
transmitting, by the UE to the NTN, an indication related to the measurement gap.

2. The method of claim 1, wherein the transmitting the indication includes:
transmitting, to the NTN and prior to an end of the measurement gap, a request to terminate the measurement gap.

3. The method of claim 2, wherein the transmitting the request includes one of:
(i) transmitting a dedicated preamble during a contention-free random access procedure (RACH),
(ii) transmitting a signal on a dedicated Physical Uplink Control Channel, PUCCH, or
(iii) performing a contention-based random access channel, RACH, procedure to acquire a resource for transmitting a Radio Resource Control RRC, message, and transmitting, using the resource, the RRC message including the request.

4. The method of claim 1, wherein the transmitting the indication includes:
transmitting, to the NTN and after the measurement gap completes, a recommendation for setting a new measurement gap.

5. The method of claim 4, wherein the recommendation includes one or more of:
(i) a length of the measurement gap,
(ii) an offset of the measurement gap in a frame, or
(iii) a periodicity of the measurement gap.

6. The method of claim 1, further comprising:
receiving, from the NTN, an indication of whether the UE is allowed to transmit the indication related to the measurement gap.

7. The method of claim 1, further comprising:
receiving, from the NTN, an uplink resource for the transmitting the indication related to the measurement gap.

8. The method of claim 1, further comprising:
receiving, from the NTN, a timing parameter related to a change in timing alignment between the UE and a node of the NTN that generates the synchronization signal;
wherein performing the measurement of the synchronization signal is based in part on the timing parameter.

9. A user equipment UE, comprising:
a transceiver; and
processing hardware configured to implement a method that includes:
receiving, by the UE from the NTN, a synchronization signal during the measurement gap in accordance with the timing pattern;
performing, by the UE, a measurement of the synchronization signal; and
transmitting, by the UE to the NTN, an indication related to the measurement gap.

10. A method for configuring synchronization signal measurement in a user equipment UE, the method implemented in a serving non-terrestrial network NTN, node and comprising:
transmitting, by the NTN node to a UE, a measurement configuration that indicates a timing pattern for inter-frequency measurement at the UE, the timing pattern having a measurement gap of a certain duration;
receiving, by the NTN node from the UE, an indication related to the measurement gap; and
modifying, by the NTN node, the timing pattern in accordance with the received indication.

11. The method of claim 10, wherein the receiving the indication includes:
receiving, from the UE and prior to an end of the measurement gap, a request to terminate the measurement gap.

12. The method of claim 11, wherein the receiving of the request includes one of:
(i) receiving a dedicated preamble during a contention-free random access procedure (RACH),
(ii) receiving a signal on a dedicated Physical Uplink Control Channel PUCCH, or
(iii) providing, to the UE and during a contention-based random access channel, RACH, procedure, a resource for transmitting a Radio Resource Control RRC, message, and receiving, over the resource, a RRC message including the request.

13. The method of claim 10, wherein the receiving of the indication includes:
receiving, after the measurement gap completes, a recommendation for setting a new measurement gap.

14. The method of claim 13, wherein the recommendation includes one or more of:
(i) a length of the measurement gap,
(ii) an offset of the measurement gap in a frame, or
(iii) a periodicity of the measurement gap.

15. A non-terrestrial network NTN, node comprising:
a transceiver, and
processing hardware and configured to implement a method of including:
transmitting, by the NTN node to a UE, a measurement configuration that indicates a timing pattern for inter-frequency measurement at the UE, the timing pattern having a measurement gap of a certain duration;
receiving, by the NTN node from the UE, an indication related to the measurement gap; and
modifying, by the NTN node, the timing pattern in accordance with the received indication.
